(19) United States
(12) Patent Application Publication
(10) Pub. No.: US 2012/0219130 A1
(43) Pub. Date: Aug. 30, 2012

(54) METHOD, DEVICE AND SYSTEM FOR MEDIA SESSION NEGOTIATION

(75) Inventors: Yu ZHU, Shenzhen (CN); Ping FANG, Shenzhen (CN); Huangwei WU, Shenzhen (CN); Qinliang ZHANG, Shenzhen (CN)

(73) Assignee: HUAWEI DEVICE CO.,LTD., Shenzhen (CN)

(21) Appl. No.: 13/465,674

(22) Filed: May 7, 2012

Related U.S. Application Data
(63) Continuation of application No. PCT/CN2010/078510, filed on Nov. 8, 2010.

(30) Foreign Application Priority Data
Nov. 6, 2009 (CN) 200910211404.4

(51) Int. Cl. H04M 11/00

(52) U.S. Cl. 379/93.01

(57) ABSTRACT

A method, a device and a system for media session negotiation are disclosed in the present invention. The method includes: receiving a first media description sent from a telephony server (TS), where the first media description includes a media session parameter of the TS at a local area network LAN side (101); forwarding the first media description to a telephony client (TC) (102); receiving a second media description which is generated by the TC according to the first media description, where the second media description includes a media session parameter of the TC (103); and forwarding the second media description to the TS (104). Through the present invention, negotiation of media session parameters between a TS and a TC in a home network may be achieved.

This application is a continuation of International Application No. PCT/CN2010/078510, filed on Nov. 8, 2010, which claims priority to Chinese Patent Application No. 200910211404.4, filed on Nov. 6, 2009, both of which are hereby incorporated by reference in their entireties

### FIELD OF THE INVENTION

The present invention relates to the field of communications technologies, and in particular, to a method, a device and a system for media session negotiation.

### BACKGROUND OF THE INVENTION

With the development of digital home, and the universal digitization of CE (Consumer Electronic, consumer electronic) products, more and more digital entertainment devices and home appliance products come into being in home. These home network devices are connected to form a home network in a wired or wireless manner, so as to achieve functions such as content sharing or mutual control, which is the digital home network concept that the industry are conceiving and striving to achieve.

In order to achieve interworking and control of various different home devices, more and more home network devices support UPnP (Universal Plug and Play, universal plug and play). In a UPnP system, a user controls a home device through a CP (Control Point, control point) in the home network, and the CP adopts a UPnP protocol and invokes an action (action) relevant to the UPnP device to read state information of a UPnP device in the home network and control the UPnP device to execute a corresponding operation.

With the continuous development of digital home and communications technologies, users not only expect to use a telephony service on a device supporting telephony, but also hope to share the telephony service in a home network. In order to achieve sharing of the telephony service in the home network, devices in the home network are required to negotiate and complete specific parameter configuration for media transfer. For example, an RTP (Real-time Transport Protocol, real-time transport protocol) protocol is used to transmit real-time streaming media, and two parties in communication cannot start to transmit media streams to each other before negotiating a communication address/port and media parameters (format, code and the like). In practice, generally an SDP (Session Description Protocol, session description protocol, rfc4566) protocol is used to describe media session parameters, and rfc3264 provides an SDP Offer/Answer Model, where two parties in multimedia communication can complete parameter negotiation through such an interaction manner.

During the implementation of the present invention, the inventor finds that the prior art has the following problems.

A device control protocol specified in UDA (UPnP Device Architecture, universal plug and play device architecture) is for use between a CP and a UPnP device, rather than between two UPnP devices. Therefore, in the prior art, two UPnP devices cannot complete negotiation of media session parameters through the UPnP protocol.

### SUMMARY OF THE INVENTION

An embodiment of the present invention provides a method for media session negotiation, for achieving negotiation of media session parameters between a telephony server and a telephony client in a home network, the method including:

receiving a first media description sent from a telephony server TS, where the first media description includes a media session parameter of the TS at a local area network LAN side;

forwarding the first media description to a telephony client TC;

receiving a second media description which is generated by the TC according to the first media description, where the second media description includes the media session parameter of the TC; and

forwarding the second media description to the TS.

An embodiment of the present invention further provides a method for media session negotiation, for achieving negotiation of media session parameters between a telephony server and a telephony client in a home network, the method including:

sending a first media description to a telephony control point TCP, where the first media description includes a media session parameter of a TS at a LAN side; and

receiving a second media description which is generated by a TC according to the first media description and forwarded by the TCP, where the second media description includes a media session parameter of the TC.

An embodiment of the present invention further provides a method for media session negotiation, for achieving negotiation of media session parameters between a telephony server and a telephony client in a home network, the method including:

receiving a first media description of a TS which is forwarded by a TCP, where the first media description includes a media session parameter of the TS at a LAN side;

generating a second media description according to the first media description, where the second media description includes a media session parameter of a TC; and

sending the second media description to the TCP, so that the TCP sends the second media description to the TS.

An embodiment of the present invention further provides a telephony control point device TCP, for achieving negotiation of media session parameters between a telephony server and a telephony client in a home network, the device including:

a first receiving module, configured to receive a first media description sent from a telephony server TS, where the first media description includes a media session parameter of the TS at a LAN side;

a first forwarding module, configured to forward the first media description to a telephony client TC;

a second receiving module, configured to receive a second media description which is generated by the TC according to the first media description, where the second media description includes a media session parameter of the TC; and

a second forwarding module, configured to forward the second media description to the TS.

An embodiment of the present invention further provides a telephony server device TS, for achieving negotiation of media session parameters between a telephony server and a telephony client in a home network, the device including:

a first sending module, configured to send a first media description to a telephony control point TCP, where the first media description includes a media session parameter of the TS at a LAN side; and

a receiving module, configured to receive a second media description which is generated by a TC according to the first media description and forwarded by the TCP, where the second media description includes a media session parameter of the TC.

An embodiment of the present invention further provides a telephony client device TC, for achieving negotiation of media session parameters between a telephony server and a telephony client in a home network, the device including:

a first receiving module, configured to receive a first media description of a TS which is forwarded by a TCP, where the first media description includes a media session parameter of the TS at a LAN side;

a generation module, configured to generate a second media description according to the first media description, where the second media description includes a media session parameter of the TC; and

a first sending module, configured to send the second media description to the TCP, so that the TCP sends the second media description to the TS.

An embodiment of the present invention further provides a media negotiation system, for achieving negotiation of media session parameters between a telephony server and a telephony client in a home network, the system including:

a telephony server device TS, configured to send a first media description, where the first media description includes a media session parameter of the TS at a local area network LAN side;

a telephony control point device TCP, configured to receive the first media description, and forward the first media description;

and a telephony client device TC, configured to receive the first media description which is forwarded by the TCP, generate a second media description according to the first media description, and send the second media description to the TCP;

where the TCP is further configured to receive the second media description which is sent from the TC, and send the second media description to the TS.

In the embodiments of the present invention, a first media description sent from a telephony server TS is received, the first media description including the media session parameter of the TS at a LAN side; the first media description is forwarded to a telephony client TC; a second media description which is generated by the TC according to the first media description is received, the second media description including the media session parameter of the TC; and the second media description is forwarded to the TS, thereby achieving negotiation of media session parameters between a telephony server and a telephony client in a home network.

In the embodiments of the present invention, a first media description is sent to a telephony control point TCP, the first media description including the media session parameter of a TS at a LAN side; and a second media description which is generated by a TC according to the first media description and forwarded by the TCP is received, the second media description including the media session parameter of the TC, thereby achieving negotiation of media session parameters between a telephony server and a telephony client in a home network.

In the embodiments of the present invention, a first media description of a TS which is forwarded by a TCP is received, the first media description including the media session parameter of the TS at a LAN side; a second media description is generated according to the first media description, the second media description including the media session parameter of a TC; and the second media description is sent to the TCP, so that the TCP sends the second media description to the TS, thereby achieving negotiation of media session parameters between a telephony server and a telephony client in a home network.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only about some embodiments of the present invention, and persons of ordinary skill in the art can derive other drawings from the accompanying drawings without creative efforts. In the accompanying drawings:

FIG. 1 is a processing flowchart of a media negotiation method according to an embodiment of the present invention;

FIG. 2 is a processing flowchart of another media negotiation method according to an embodiment of the present invention;

FIG. 3 is a processing flowchart of still another media negotiation method according to an embodiment of the present invention;

FIG. 4 is a processing flowchart of a media negotiation method according to Embodiment 1 of the present invention;

FIG. 5 is a processing flowchart of a media negotiation method according to Embodiment 2(A) of the present invention;

FIG. 6 is a processing flowchart of a media negotiation method according to Embodiment 2(B) of the present invention;

FIG. 7 is a processing flowchart of a media negotiation method according to

Embodiment 3(A) of the present invention;

FIG. 8 is a processing flowchart of a media negotiation method according to Embodiment 3(B) of the present invention;

FIG. 9 is a processing flowchart of a media negotiation method according to Embodiment 4 of the present invention;

FIG. 10 is a processing flowchart of a media negotiation method according to Embodiment 5 of the present invention;

FIG. 10A is a schematic flowchart of Implementation Scenario 1 of a media negotiation method according to an embodiment of the present invention;

FIG. 10B is a schematic flowchart of Implementation Scenario 2 of a media negotiation method according to an embodiment of the present invention;

FIG. 11 is a schematic structural diagram of a telephony control point device according to an embodiment of the present invention;

FIG. 12 is a schematic structural diagram of a specific instance of a telephony control point device according to an embodiment of the present invention;

FIG. 13 is a schematic structural diagram of another specific instance of a telephony control point device according to an embodiment of the present invention;

FIG. 14 is a schematic structural diagram of a telephony server device according to an embodiment of the present invention;

FIG. 15 is a schematic structural diagram of a specific instance of a telephony server device according to an embodiment of the present invention;

FIG. 16 is a schematic structural diagram of another specific instance of a telephony server device according to an embodiment of the present invention;

FIG. 17 is a schematic structural diagram of a telephony client device according to an embodiment of the present invention;

FIG. 18 is a schematic structural diagram of a specific instance of a telephony client device according to an embodiment of the present invention;

FIG. 19 is a schematic structural diagram of another specific instance of a telephony client device according to an embodiment of the present invention;

FIG. 20 is a schematic structural diagram of still another specific instance of a telephony client device according to an embodiment of the present invention; and

FIG. 21 is a schematic structural diagram of a media negotiation system according to an embodiment of the present invention.

### DETAILED DESCRIPTION OF THE EMBODIMENTS

In order to make the objectives, technical solutions, and advantages of the embodiments of the present invention more comprehensible, embodiments of the present invention are described in further detail below with reference to the accompanying drawings. Here, the exemplary embodiments of the present invention and the illustrations of the embodiments are only intended to explain the present invention, rather than limit the present invention.

For the convenience of description, three devices: TCP (Telephony Control Point, telephony control point), TC (Telephony Client, telephony client) and TS (Telephony Server, telephony server), that are involved to achieve sharing of a telephony service in a home network in embodiments of the present invention are illustrated briefly first. Herein, the TS is a device capable of providing a telephony function for other devices in the home network, such as a mobile phone; the TC is a device capable of receiving and presenting media/data from the TS in the home network, and/or capable of providing media/data to the TS, such as a TV; and the TCP is configured to control the TS and the TC in the home network, so as to achieve sharing of the telephony service in the home network. Negotiation of media session parameters between two UPnP devices as described in the prior art refers to negotiation of media session parameters between the telephony server and the telephony client.

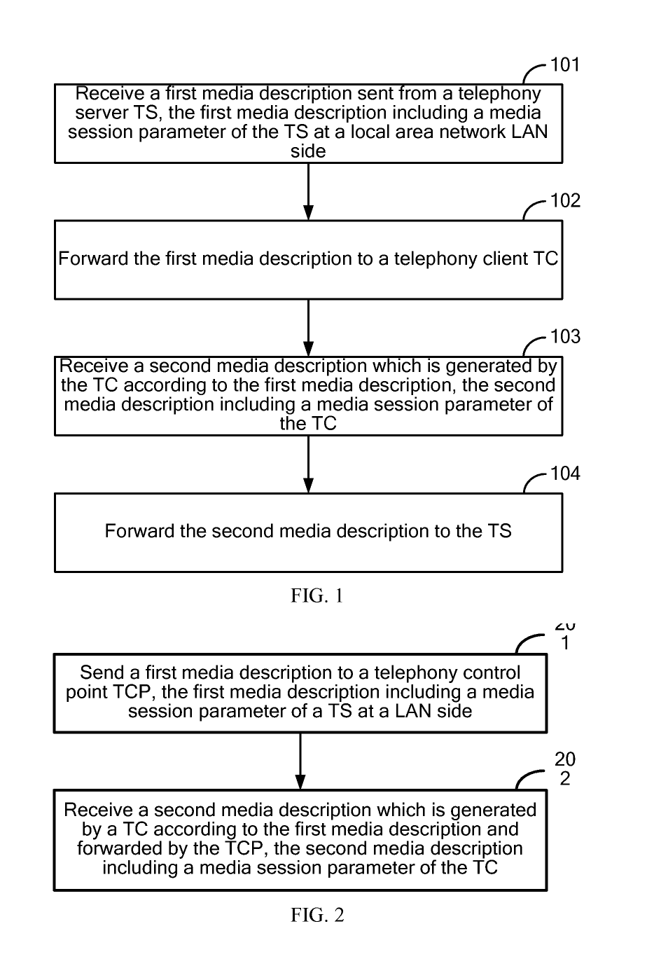

In order to achieve negotiation of media session parameters between the telephony server and the telephony client in the home network, as shown in FIG. 1, an embodiment of the present invention provides the following media negotiation method, where the method may include:

Step 101: receiving a first media description sent from a telephony server TS, where the first media description includes a media session parameter of the TS at a LAN (Local Area Network, local area network) side;

Step 102: forwarding the first media description to a telephony client TC;

Step 103: receiving a second media description which is generated by the TC according to the first media description, where the second media description includes a media session parameter of the TC; and

Step 104: forwarding the second media description to the TS.

It can be learned from the process shown in FIG. 1 that, in the embodiment of the present invention, a first media description sent from a telephony server TS is received, where the first media description includes a media session parameter of the TS at a LAN side; the first media description is forwarded to a telephony client TC; a second media description which is generated by the TC according to the first media description is received, where the second media description includes a media session parameter of the TC; and the second media description is forwarded to the TS, thereby achieving negotiation of media session parameters between a telephony server and a telephony client in a home network. With this embodiment, working efficiency is high, and the complexity of device implementation is low.

The process shown in FIG. 1 may be implemented by the TCP, and definitely may also be implemented by a device capable of realizing the function thereof, and in the embodiment of the present invention, the TCP is taken as an example for illustration.

In order to achieve negotiation of media session parameters between a telephony server and a telephony client in a home network, as shown in FIG. 2, an embodiment of the present invention further provides the following media negotiation method, where the method may include:

Step 201: sending a first media description to a telephony control point TCP, where the first media description includes a media session parameter of a TS at a LAN side; and

Step 202: receiving a second media description which is generated by a TC according to the first media description and forwarded by the TCP, where the second media description includes a media session parameter of the TC.

It can be learned from the process shown in FIG. 2 that, in the embodiment of the present invention, a first media description is sent to a telephony control point TCP, where the first media description includes a media session parameter of a TS at a LAN side; and a second media description which is generated by a TC according to the first media description and forwarded by the TCP is received, where the second media description includes a media session parameter of the TC, thereby achieving negotiation of media session parameters between a telephony server and a telephony client in a home network. With this embodiment, working efficiency is high, and the complexity of device implementation is low.

The process shown in FIG. 2 may be implemented by the TS, and definitely may also be implemented by a device capable of realizing the function thereof, and in the embodiment of the present invention, the TS is taken as an example for illustration.

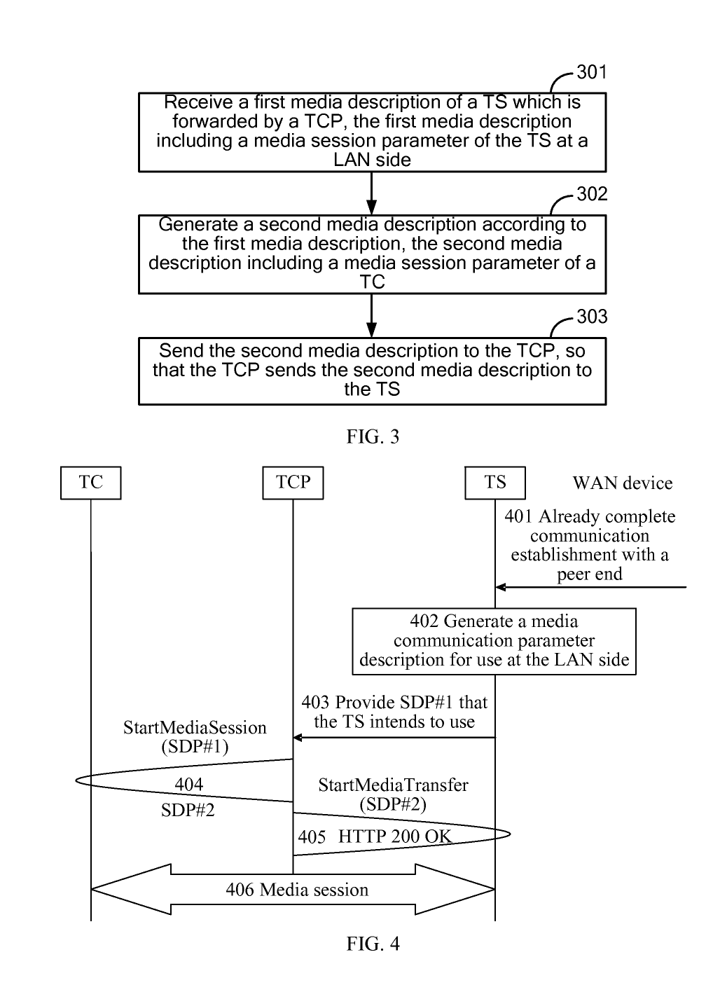

In order to achieve negotiation of media session parameters between a telephony server and a telephony client in a home network, as shown in FIG. 3, an embodiment of the present invention further provides the following media negotiation method, where the method may include:

Step 301: receiving a first media description of a TS which is forwarded by a TCP, where the first media description includes a media session parameter of the TS at a LAN side;

Step 302: generating a second media description according to the first media description, where the second media description includes a media session parameter of a TC; and

Step 303: sending the second media description to the TCP, so that the TCP sends the second media description to the TS.

It can be learned from the process shown in FIG. 3 that, in the embodiment of the present invention, a first media description of a TS which is forwarded by a TCP is received, where the first media description includes a media session parameter of the TS at a LAN side; a second media description is generated according to the first media description, where the second media description includes a media session parameter of a TC; and the second media description is sent to the TCP, so that the TCP sends the second media description to the TS, thereby achieving negotiation of media session parameters between a telephony server and a telephony client in a home network. With this embodiment, working efficiency is high, and the complexity of device implementation is low.

The process shown in FIG. 3 may be implemented by the TC, and definitely may also be implemented by a device capable of realizing the function thereof, and in the embodiment of the present invention, the TC is taken as an example for illustration.

In addition, during implementation, a media session parameter may be described by using an SDP protocol, or other description manners, and in subsequent embodiments, illustration is provided through an example where a media session parameter is described by using the SDP protocol.

### Embodiment 1

As described above, in the embodiment of the present invention, a TCP, as an intermediary for media negotiation between a TS and a TC, obtains a first media description, denoted by SDP#1, of the TS; and sends the first media description to the TC, so that the TC generates the second media description of the TC, denoted by SDP#2, according to the first media description; and then the TCP sends the second media description of the TC to the TS. In this way, both the TS and the TC obtain the media description of each other, and a media session (such as an

RTP session) may be directly started.

The embodiment of the present invention satisfies the SDP Offer/Answer Model defined in rfc3264: SDP#1 is equivalent to an Offer from the first party (TS), and SDP#2 is equivalent to an Answer generated by the second party (TC) according to the Offer; herein, the TCP serves as an intermediary for information exchange between the two parties, which solves the problem that the TS and the TC cannot access each other directly through the UPnP protocol, and simplifies the process of negotiation between the TS and the TC, as exchange of media parameters is not required any more.

It should be noted that, the media description described in the present invention may specifically be a part of a state variable (State Variable, SV) or an action argument that describes media parameters/capabilities according to the syntax specified in the SDP and is encapsulated in an XML (Extensible Markup Language, extensible markup language) format.

Optionally, the first media description may further include media session information of the TS at a WAN (Wide Area Network, wide area network) side; during specific implementation, the media session information of the TS at the WAN side may include a media code used by the TS at the WAN side; and the media session parameter of the TS at a LAN side may include any one of or any combination of a receiving media address, a receiving media port and a used media code of the TS at the LAN side.

The specific content of the media description SDP#1 is for example:

v=0

o=−0 0 IN IP4 192.168.1.10

s=

c=IN IP4 192.168.1.10/127

t=0 0

a=sendrecv

m=audio 1234 RTP/AVP 0

a=rtpmap:0 PCMU/8000

m=video 2345 RTP/AVP 96

b=AS:48

a=rtpmap:96 MP4V-ES/90000

Herein, “c=” represents an IP address through which an SDP provider can be contacted, and is generally a media stream receiving address. “m=” provides a media format (audio/video, receiving port, code) that the device supports or intends to use. In order to start a media session subsequently, it is very important for a peer end to obtain information, such as media information or connection address/port, provided by the device.

Therefore, the generating, by the TC, the second media description according to the first media description may include:

generating the second media description according to any one of or any combination of media format information, address information and port information in the first media description.

The process where the TCP serves as an intermediary for negotiation of media parameters between the TS and the TC is illustrated below through an example, so as to illustrate the process of implementing the SDP Offer/Answer Model in the embodiment of the present invention. As shown in FIG. 4, the process of the media negotiation method in this example may include:

Step 401: The TS (such as a mobile phone, a fixed-line phone, a VoIP gateway or other devices) already completes call establishment with a communication peer at the WAN side (for example, completes an exchange process from SIP (Session Initiation Protocol, session initiation protocol) Invite to SIP ACK).

Step 402: The TS converts the description of communication establishment at the WAN side to the description that should be used at the LAN (Local Area Network, local area network) side, that is, SDP#1.

In this step, the TS converts a media parameter description for use at the WAN side to a parameter description of a media session expected to be established at the LAN side. For example, when the SDP is used for description, the media description at the WAN side may be SDP#0, a WAN IP address of the TS device may be described, and multimedia communication that has been established with the peer end and includes audio and video and ports that are used to receive them may be described. At this time, the TS may expect that the session established at the LAN side with the TC includes all of the above media, and information such as address/port for performing the media session with the TC only needs to be specified.

The TS converts the SDP at the WAN side to SDP#1 at the LAN side, and in this example, the TS expects that the communication between the TS and the TC includes all media in the communication with the WAN, and therefore only converts a communication address/port to an address/port at the LAN side.

Step 403: The TS provides SDP#1 to the TCP.

The TS may provide SDP#1 to the TCP in various manners, for example:

A: SDP#1 is sent to the TCP through an event, where the event may be sent through a GENA (General Event Notification Architecture, general event notification architecture) protocol.

B: A UPnP action (action) is defined, the TCP invokes the action, and the TS returns SDP#1 to the TCP through a response. For example, a GetMediaDescription( )action is defined, the TCP indicates through the action that the parameter description of the media communication that the TS intends to establish at the LAN side needs to be obtained, and the TS will carry a parameter including SDP#1 in a response message.

Step 404: The TCP provides the media description SDP#1 (equivalent to an SDP Offer) from the TS to the TC, and according to the information, the TC returns, to the TCP, a description SDP#2 (equivalent to an SDP Answer) of a media parameter to be used by the TC.

For example, SDP#2 returned by the TC according to the foregoing example of SDP#1 in combination with the capability of the TC may be as follows:

v=0

o=−0 0 IN IP4 192.168.0.35

s=

c=IN IP4 192.168.0.35/127

t=0 0

m=audio 2324 RTP/AVP 0

a=rtpmap:0 PCMU/8000

m=video 3435 RTP/AVP 96

b=AS:48

a=rtpmap:96 MP4V-ES/90000

Step 405: The TCP sends the media description SDP#2 from the TC to the TS, so that the TS obtains information of the TC, and subsequently a media session can be started according to the media parameter information of the two parties.

Step 406: A media session is started between the TS and the TC according to the above media parameters, where the media session may adopt protocols, such as RTP, HTTP, TCP (Transport Control Protocol, transport control protocol) and UDP.

In this embodiment, the TC supports all media formats provided by the TS, so that the returned SDP#2 provides an address/port with which the TC receives a media stream, and is substantially the same as SDP#1 in the aspect of media format description. However, during implementation, the TC may not support all of the content in SDP#1, for example, may not support a Video MP4V-ES format, and reference may be made to subsequent embodiments for a processing method.

### Embodiment 2

This embodiment mainly specifies Embodiment 1 in that, the TCP not only serves as an intermediary, but also performs necessary modification on selection of media parameters according to media capabilities of the two parties, so that one Offer/Answer exchange is enough to determine media session parameters that are finally used by the two parties. During implementation, media capabilities may be described by using an SDP protocol, or other description manners, and in subsequent embodiments, illustration is provided through an example where media capabilities are described by using the SDP protocol.

### Embodiment 2(A)

In this embodiment, the TCP modifies SDP#1 according to the capabilities of the TC and the TS, and the modified SDP#1 is provided to the TC after content that the TC does not support is deleted (SDP#1′), so that the TC may completely accept media formats provided therein; and the TCP sends SDP#1′ to the TS, indicating that SDP#1′ is the final media description that the TS should adopt.

In this embodiment, the TCP, the TS and the TC are implemented as follows:

The TCP obtains the media capability of the TC, and modifies the first media description according to the media capability of the TC; forwards the modified first media description to the TC; receives the second media description which is generated by the TC according to the modified first media description; and further includes: forwarding the modified first media description to the TS.

The TS receives the modified first media description and the second media description which is generated by the TC according to the modified first media description, where the modified first media description is obtained after the TCP modifies the first media description according to the media capability of the TC.

The TC provides the media capabilities of the TC to the TCP before receiving the first media description; subsequently receives the first media description which is modified by the TCP according to the media capability of the TC after the TCP receives the first media description sent from the TS; and generates the second media description according to the modified first media description.

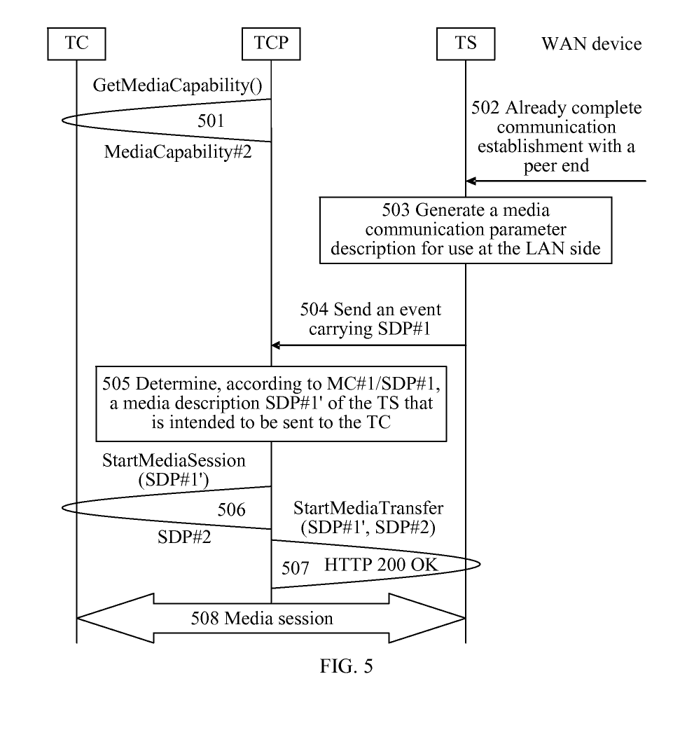

As shown in FIG. 5, a specific process of this embodiment may include:

Step 501: The TCP obtains in advance the media capability supported by the TC (definitely may also obtain the media capability of the TS). This step may be independent of communication establishment at the WAN side, that is, the capability may be determined before the TS establishes a call with a WAN side device, or obtained during the process where the TS negotiates with the WAN side device about communication parameters, or after the negotiation is completed (for example, negotiation through an SIP protocol) and communication is already established.

1) The TCP may specifically obtain the media capability(MediaCapability), which are supported by the TC, through a UPnP action, for example, a GetMediaCapability( )action is defined, and the TC provides the media capability, which is supported by the device, to the TCP through an action response message.

2) The description of media capabilities may include the following information, or may also use other formats. All media capabilities supported by the TC may be shown as follows (MediaCapability#2):

m=audio 0 RTP/AVP 0 1

a=rtpmap:0 PCMU/8000

a=rtpmap : 1 1016/8000

m=video 0 RTP/AVP 31

a=rtpmap:31 H261/90000

Step 502: The TS (such as a mobile phone, a fixed-line phone, a VoIP gateway or other devices) already completes call establishment with a communication peer at the WAN side (for example, completes an exchange process from SIP Invite to SIP ACK).

Step 503: The TS converts the description of communication establishment at the WAN side to the description that should be used at the LAN (Local Area Network, local area network) side, that is, SDP#1.

Step 504: The TS provides the first media description to the TCP.

Step 505: After obtaining the media description SDP#1 from the TS, the TCP determines a media description SDP#1′ of the TS, which should be sent to the TC, based on the previously obtained media capability supported by the TC (optionally with reference to the capability supported by the TS).

1) The media description SDP#1 from the TS may be shown as follows:

v=0

o=−0 0 IN IP4 192.168.0.10

s=

c=IN IP4 192.168.0.10/127

t=0 0

m=audio 3456 RTP/AVP 0

a=rtpmap:0 PCMU/8000

m=video 4567 RTP/AVP 34

a=rtpmap:34 H263/90000

Herein, the TS will use a video stream of an H.263 coding format at the WAN side, and the TCP may determine, according to the capability of the TC, that the TC does not support the media format. In this embodiment, the TCP determines, according to the above determination, that H.263 streams cannot be transmitted between the TC and the TS, and therefore chooses to transmit only PCMU voice streams before them.

2) According to the above determination, the TCP determines that the modified media description SDP#1′ of the TS that should be sent to the TC is shown as follows. Here, SDP#1′ is equivalent to an SDP Offer, and the Offer should be accepted by the TC, and is a final version that the TS should use.

v=0

0=−0 0 IN IP4 192.168.0.10

s=

c=IN IP4 192.168.0.10/127

t=0 0

m=audio 3456 RTP/AVP 0

a=rtpmap:0 PCMU/8000

3) The TCP may send the media description of the TS to the TC through a UPnP action (for example, StartMediaSession( )), and carry SDP#1′ in the action request message, and the TC accepts the “Offer” and returns a response message carrying SDP#2 “Answer”. Moreover, the TCP may also carry other information, such as the original description SDP#1 of the TS, in the StartMediaSession( )request message; the TC may also carry MediaSessionID (uniquely identifying the media session to be conducted with the TS) in the response message thereof.

Step 506: The TCP sends SDP#1′ to the TC, and receives SDP#2 generated by the TC according to SDP#1.

Step 507: The TCP also needs to provide SDP#1′ to the TS while sending SDP#2 from the TC to the TS, as SDP#1′ is a media parameter that the TS end should use during communication between the TS and the TC. The TS uses SDP#1′ to replace SDP#1 to serve as a final version of the media parameter for communication between the TS and the TC.

1) Specifically, the TCP may carry SDP#1′ and SDP#2 in a UPnP action (for example, StartMediaTransfer( )), and the TS accepts the two and prepares to establish a media session with the TC. Moreover, in the request message, the TCP may also carry MediaSessionID from the TC, and/or a CallID which is generated by the TS and used for uniquely identifying the communication with the WAN (the CallID may be generated by the TS and provided to the TCP through an event manner when the communication between the TS and a WAN side device is started).

Step 508: A media session is started between the TS and the TC according to the above media parameters, where the media session may adopt protocols such as RTP, HTTP, TCP and UDP.

### Embodiment 2(B)

In this embodiment, by comparing capabilities of the TC and the TS, the TCP learns that the TC does not support media formats such as H.263, but both the TC and the TS support H.261. Therefore, the TCP converts H.263-related content in SDP#1 into H.261-related content (SDP#1′), and sends the content to the TC, and the TC accepts the content and returns SDP#2. The TCP sends SDP#1′ and SDP#2 to the TS, indicating that a media session that is to be established by the TS with the TC will adopt an H.261 coding format, but the TS needs to execute a transcoding function: to convert a media stream in the H.263 coding format from the WAN side to a media stream in the H.261 coding format and send the stream to the TC, and to convert a media stream in the H.261 coding format from the TC to a media stream in the H.263 and send the stream to a communication peer at the WAN side. In this embodiment, the TCP, the TS and the TC are implemented as follows:

The TCP obtains media capabilities of the TC and the TS and modifies the first media description according to the media capabilities of the TC and the TS; forwards the modified first media description to the TC; receives the second media description which is generated by the TC according to the modified first media description; and further includes: forwarding the modified first media description to the TS.

The TS receives the modified first media description and the second media description which is generated by the TC according to the modified first media description, where the modified first media description is obtained after the TCP modifies the first media description according to the media capabilities of the TC and the TS.

The TC provides media capabilities of the TC to the TCP before receiving the first media description; subsequently receives the first media description that is modified by the TCP according to the media capabilities of the TC and the TS after the TCP receives the first media description sent from the TS; and generates the second media description according to the modified first media description.

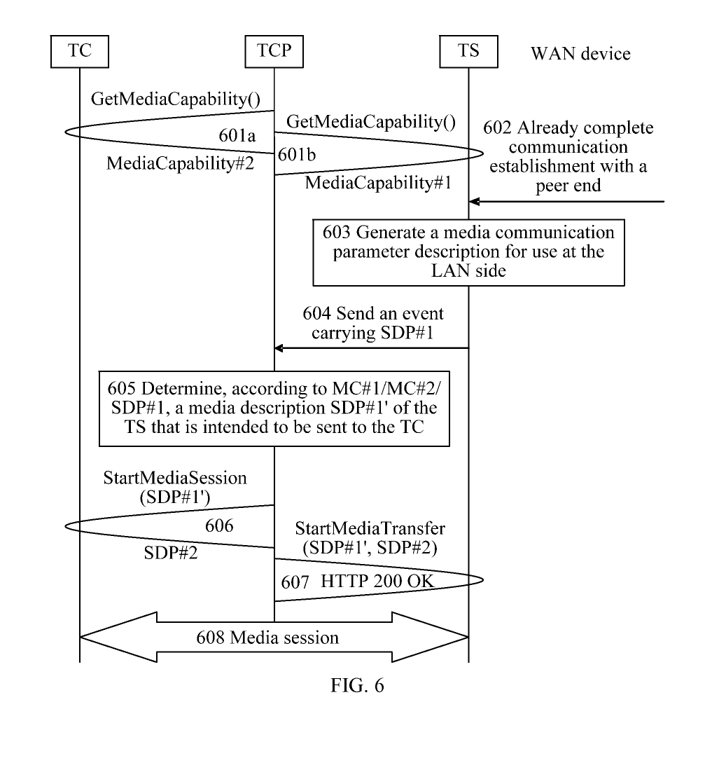

A specific process in this example is shown in FIG. 6, which is mainly different from the steps provided in Embodiment 2(A) in that, when the TS and the TC use different media formats, the TS adopts a transcoding technology to solve the problem. The processing process in FIG. 6 may include:

Steps 601a-601b: The TCP needs to obtain media capabilities of the TS and the TC in advance. For example,

A. The media capabilities of the TC are MediaCapability#2 (MC#2):

m=audio 0 RTP/AVP 0 1

a=rtpmap:0 PCMU/8000

a=rtpmap:1 1016/8000

m=video 0 RTP/AVP 31

a=rtpmap:31 H261/90000

B. The media capabilities of the TS are MediaCapability#1 (MC#1):

m=audio 0 RTP/AVP 0 1 3

a=rtpmap:0 PCMU/8000

a=rtpmap : 1 1016/8000

a=rtpmap:3 GSM/8000

m=video 0 RTP/AVP 31 34

a=rtpmap:31 H261/90000

a=rtpmap:34 H263/90000

It can be learned that, the media capability of the TC as compared with those of the TS are that: GSM is not supported for audio, and H.263 coding is not supported for video.

Step 602: The TS (such as a mobile phone, a fixed-line phone, a VoIP gateway or other devices) already completes call establishment with a communication peer at the WAN side (for example, completes an exchange process from SIP Invite to SIP ACK).

Step 603: The TS converts the description of communication establishment at the WAN side to the description that should be used at the LAN (Local Area Network, local area network) side, that is, SDP#1.

Step 604: The TS provides the first media description to the TCP.

Step 605: After receiving SDP#1 from the TS, the TCP determines, according to MC#1/MC#2/SDP#1, the media description (SDP#1′) of the TS that should be provided to the TC.

1) For example, SDP#1 from the TS is (coding at the WAN side: PCMU for audio, H.263 for video):

v=0

o=−0 0 IN IP4 192.168.0.10

s=

c=IN IP4 192.168.0.10/127

t=0 0

m=audio 3456 RTP/AVP 0

a=rtpmap:0 PCMU/8000

m=video 4567 RTP/AVP 34

a=rtpmap:34 H263/90000

2) By analyzing the previously obtained MC#1/MC#2 in combination with SDP#1, the TCP can learn that an H.261 stream may be established between the TS and the TC, so that video data may not be discarded. However, the TS is required to perform transcoding. Therefore, a final media description SDP#1′ of the TS that the TCP determines to provide to the TC should be as follows, for example:

v=0

o=−0 0 IN IP4 192.168.0.10

s=

c=IN IP4 192.168.0.10/127

t=0 0

m=audio 3456 RTP/AVP 0

a=rtpmap:0 PCMU/8000

m=video 4567 RTP/AVP 31

a=rtpmap:31 H261/90000

Step 606: The TCP sends SDP#1′ to the TC, and receives SDP#2 generated by the TC according to SDP#1. In this example, as the TC supports H.261,the TC may accept SDP#1′ and return SDP#2 as a media parameter description of the TC.

Step 607: The TCP provides SDP#2 and the modified SDP#1′ to the TS.

Step 608: A media session is started between the TS and the TC according to the above media parameters, where the media session may adopt protocols such as RTP, HTTP, TCP and UDP. For the TS, in this embodiment, it can be learned by comparing the received SDP#1′ and SDP#1 that video coding is replaced by the TCP, and therefore the behavior of the device should be: to subsequently transcode an H.263 video stream from the WAN side to an H.261 video stream, and send the stream to the TC; and transcode an H.261 video stream from the TC to an H.263 video stream, and send the stream to a communication peer at the WAN side.

In an embodiment of the present invention, when providing SDP#1, the TS may also provide transcoding information supported by the TS, for example, if the WAN side uses coding being H.263, the transcoding information provided by the TS may include H.261, H.264 and the like, and the transcoding information may also include information, such as a port to be used. The TCP may select one type of coding (for example, select H.261), which may be supported by the TC, from the transcoding information, which is provided by the TS, according to the transcoding information provided by the TS and the capability of the TC (for example, the TC may not support H.263), and send the modified SDP#1′ (only including information related to H.261 coding) to the TC, and the TC accepts the modified SDP#1′ and returns SDP#2. The TCP sends SDP#2 (also may send SDP#1′ at the same time) to the TS, indicating that a media session to be established by the TS with the TC will adopt an H.261 coding format, but the TS needs to execute a transcoding function: to convert a media stream in the H.263 coding format from the WAN side to a media stream in the H.261 coding format and send the stream to the TC, and to convert a media stream in the H.261 coding format from the TC to a media stream in the H.263 coding format and send the stream to the communication peer at the WAN side.

In this embodiment, as the TS already provides the transcoding information, the TCP can perform transcoding selection according to the information and the capability of the TC, and obtain suitable SDP#1′ through modification. Therefore, the TCP may not necessarily send SDP#1′ to the TS when sending SDP#2 to the TS.

In Embodiment 2(A) and Embodiment 2(B), the reason why the TCP modifies (removes) content in SDP#1 and sends the content to the TC is that: the TC does not support all the content in SDP#1. During specific implementation, the TCP may modify (remove) the content in SDP#1 and send the content to the TC due to various reasons, for example, the TCP uses two or more TCs to simultaneously conduct media sessions with the TS (for example, one TC conducts an audio session with the TS, and one TC conducts a video session with the TS). At this time, the TCP may modify SDP#1 into SDP#1′ which only includes Media#1 and send SDP#1′ to TC#1, and modify SDP#1 into SDP#1″ which only includes Media#2 and send SDP#1″ to TC#2, and TC#1/TC#2 may return SDP#2/SDP#3 respectively according to SDP#1′/SDP#1″. Then, the TCP respectively sends SDP#2 and SDP#3 to the TS, indicating the TS that media sessions of Media#1/Media#2 are respectively conducted with TC#1/TC#2.

### Embodiment 3

In this embodiment, the TCP only serves as an intermediary to provide, to the TS/TC, media description information of peer ends, and optionally provide media capability information of the peer ends. The TS and the TC select and determine their respective media parameters that are to be used, depending completely on their respective judgment basis.

### Embodiment 3(A)

In this embodiment, the TC returns SDP#2 according to SDP#1, and the TCP provides SDP#2 to the TS; the TS modifies SDP#1 accordingly to enable SDP#1 to match the content in SDP#2; the TCP uses SDP#1′, which is modified by the TS, as a final version of the TS, and sends SDP#1′ to the TC, so that the two may subsequently start communication.

In this embodiment, the TCP, the TS and the TC are implemented as follows:

The TCP further receives the first media description modified by the TS according to the first media description and the second media description; and forwards the modified first media description to the TC.

The TS sends the first media description that is modified according to the first media description and the second media description to the TCP, so that the TCP sends the modified first media description to the TC.

The TC further receives the first media description that is modified by the TS according to the first media description and the second media description and is forwarded by the TCP.

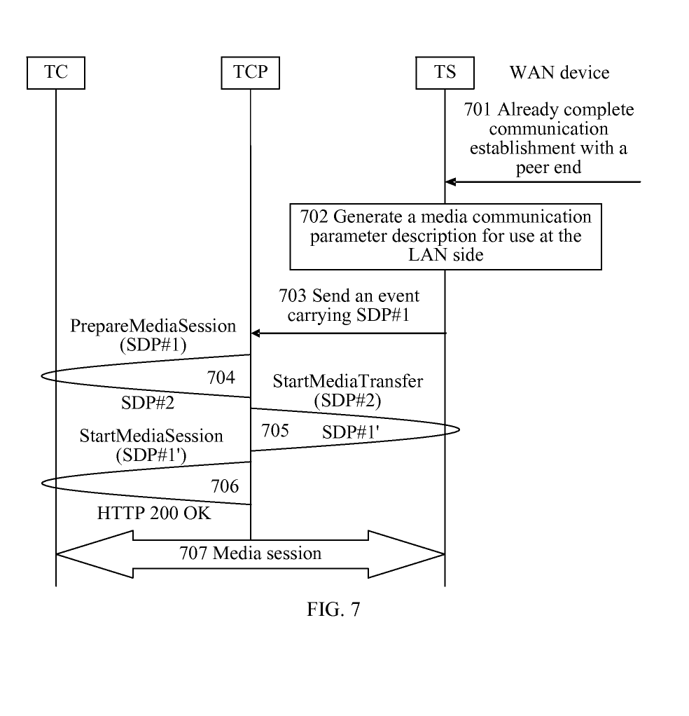

A specific process as shown in FIG. 7 may include:

Step 701: The TS (such as a mobile phone, a fixed-line phone, a VoIP gateway or other devices) already completes call establishment with a communication peer at the WAN side (for example, completes an exchange process from SIP Invite to SIP ACK).

Step 702: The TS converts the description of communication establishment at the WAN side to the description that should be used at the LAN (Local Area Network, local area network) side, that is, SDP#1.

Step 703: The TS provides SDP#1 to the TCP.

Step 704: The TCP obtains an event from the TS, indicating that the communication at the WAN side is already established, where an event message provides the parameter description SDP#1 of the TS that will be used for media communication at the LAN side; the TCP sends the media description SDP#1 (SDP Offer) from the TS to the TC, and the TC returns a media description SDP#2 (SDP Answer) of the TC according to SDP#1 in combination with the capability of the TC.

1) If the TC satisfies the media formats provided by SDP#1, it is the same as Embodiment 1.

2) In this embodiment, it is assumed that the TC only satisfies a part of the media formats provided by SDP#1. For example,

A. The media description SDP#1 from the TS may specifically be:

v=0

o=−0 0 IN 1P4 192.168.0.10

s=

c=IN IP4 192.168.0.10/127

t=0 0

m=audio 3456 RTP/AVP 0

a=rtpmap:0 PCMU/8000

m=video 4567 RTP/AVP 34

a=rtpmap:34 H263/90000

However, the TC does not support the H.263 media coding format therein, and in this embodiment, the TC determines, according to a policy of the TC, that the media communication with the TS does not include H.263 video streams.

B. Therefore, SDP#2 returned by the TC may specifically be:

v=0

o=−0 0 IN 1P4 192.168.0.35

s=

c=IN 1P4 192.168.0.35/127

t=0 0

m=audio 2324 RTP/AVP 0

a=rtpmap:0 PCMU/8000

Step 705: The TCP sends the media description SDP#2 from the TC to the TS, and the TS may compare SDP#2 with SDP#1, generate a final media parameter description SDP#1′ used for conducting a media session with the TC, and returns SDP#1′ to the TCP.

1) In this example, SDP#2 returned by the TC does not include the H.263 media format in SDP#1, so that after the TS receives SDP#2 (SDP Answer) and compares SDP#2 (SDP Answer) with SDP#1 (SDP Offer), the TS finds this. The TS may accept, and return the final media description SDP#1′.

A. SDP#1′ returned by the TS may specifically be as follows:

v=0

o=−0 0 IN IP4 192.168.0.10

s=

c=IN IP4 192.168.0.10/127

t=0 0

m=audio 3456 RTP/AVP 0

a=rtpmap:0 PCMU/8000

2) In addition, the TS may also choose, according to a policy of the TS, not to conduct a media session with the TC, as the TC cannot satisfy all the media provided by the TS.

Step 706: The TCP sends the final description SDP#1′ from the TS to the TC, indicating that this is the final version to be used by the TS.

Step 707: The TS and the TC start a media session according to media session parameters described in SDP#2/SDP#1′. In this example, the TC establishes a media session, which only includes PCMU audio, with the TS.

### Embodiment 3(B)

In this embodiment, the TCP sends SDP#1 from the TS together with the media capability supported by the TS to the TC for selection; the TC performs selection according to the media capability of the TC and uses H.261 with the TS, and accordingly returns SDP#2; the TCP sends SDP#2 to the TS, so that the TS learns that the TC does not support H.263, and uses H.261 instead, and the TS needs to perform transcoding.

In this embodiment, the TCP, the TS and the TC are implemented as follows:

Before receiving the second media description which is generated by the TC according to the first media description, the TCP further includes: obtaining the media capability of the TS and forwarding the media capabilities of the TS to the TC; and receiving the second media description which is generated by the TC according to the media capabilities of the TS and TC and the first media description.

The TS receives the second media description which is generated by the TC according to the media capabilities of the TS and the TC and the first media description and forwarded by the TCP.

The TC receives the media capability of the TS which is forwarded by the TCP; and generates the second media description according to the media capabilities of the TS and the TC and the first media description.

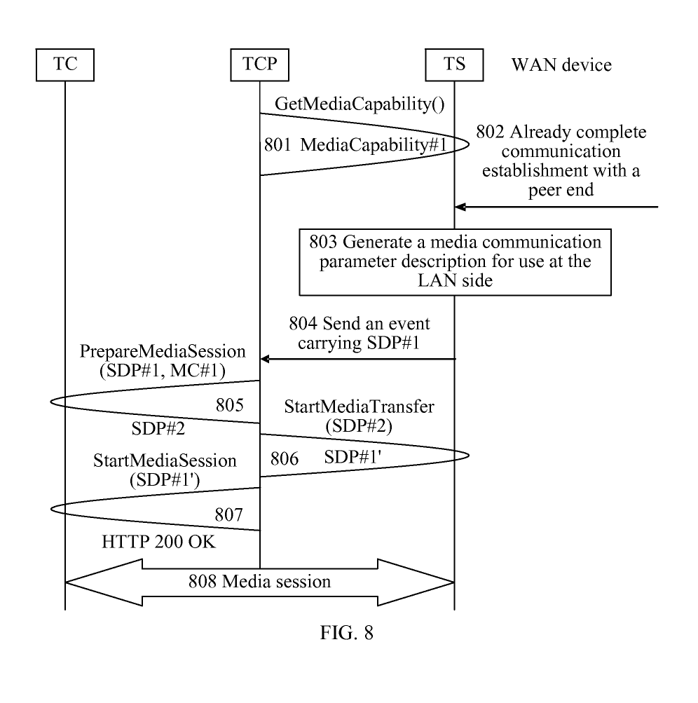

The process in this example is similar to the steps provided in Embodiment 3(A), and the difference lies in the processing behaviors of the TC/TS, and the difference lies in that the TCP further needs to provide media capability information supported by a peer end to the TC, for providing reference to the TC to select an alternative media format, so as to indicate that the TS is required to perform the transcoding. As shown in FIG. 8, a specific processing process may include:

Step 801: The TCP obtains the media capabilityMediaCapability#1 of the TS (may also obtain the capability of the TC).

Step 802: The TS (such as a mobile phone, a fixed-line phone, a VoIP gateway or other devices) already completes call establishment with a communication peer at the WAN side (for example, completes an exchange process from SIP Invite to SIP ACK).

Step 803: The TS converts the description of communication establishment at the WAN side to the description that should be used at the LAN (Local Area Network, local area network) side, that is, SDP#1.

Step 804: The TS provides SDP#1 to the TCP.

Step 805: The TCP obtains the media description SDP#1 which is intended to be used for media communication at the LAN side and is from the TS, and sends the media description SDP#1 from the TS and the media capabilityMC#1 of the TS together to the TC, for providing the reference to the TC.

1) This embodiment mainly considers the case where the TC does not support a certain/some media formats in SDP#1, and the TC determines a transcoding scheme according to the capabilities of the TC and the TS.

A. The media description SDP#1 from the TS may specifically be:

v=0

o=−0 0 IN IP4 192.168.0.10

s=

c=IN IP4 192.168.0.10/127

t=0 0

m=audio 3456 RTP/AVP 0

a=rtpmap:0 PCMU/8000

m=video 4567 RTP/AVP 34

a=rtpmap:34 H263/90000

B. The media capability description MC#1 from the TS may specifically be:

m=audio 0 RTP/AVP 0 1 3

a=rtpmap:0 PCMU/8000

a=rtpmap:1 1016/8000

a=rtpmap:3 GSM/8000

m=video 0 RTP/AVP 31 34 96

a=rtpmap:31 H261/90000

a=rtpmap:34 H263/90000

a=rtpmap:96 MP4V-ES/90000

2) The TC performs judgment according to SDP#1, MC#1 and the capability of the TC. For example, the TC does not support H.263 video coding provided in SDP#1, but supports H.261, and finds that the TS also supports H.261. Therefore, the TC may draw a conclusion according to a policy of the TC that: H.261 may be used as an alternative video stream coding scheme.

3) The TC returns a media description SDP#2 according to the judgment result, which may specifically be as follows:

v=0

o=−0 0 IN IP4 192.168.0.35

s=

c=IN IP4 192.168.0.35/127

t=0 0

m=audio 2324 RTP/AVP 0

a=rtpmap:0 PCMU/8000

m=video 3435 RTP/AVP 31

a=rtpmap:31 H261/90000

Step 806: The TCP sends the media description SDP#2 from the TC to the TS.

1) The TS may choose to reject the transcoding scheme from the TC according to a policy of the TS (for example, not inclined to perform transcoding); or,

2) Accept the media description from the TC, and finally determine and return SDP#1′ according to SDP#2.

A. SDP#1′ determined by the TS may specifically be as follows:

v=0

o=−0 0 IN IP4 192.168.0.10

s=

c=IN IP4 192.168.0.10/127

t=0 0

m=audio 3456 RTP/AVP 0

a=rtpmap:0 PCMU/8000

m=video 5678 RTP/AVP 31

a=rtpmap:31 H261/90000

Step 807: The TCP sends the final media description version SDP#1′ from the TS to the TC, instructing the two parties to start a media session through the media parameters described in SDP#2 and SDP#1′.

Step 808: Subsequently, the media session between the TS and the TC uses audio PCMU coding and video H.261 coding for transmission. The TS is required to transcode H.261 codes from the TC into an H.263 video stream and send the stream to a communication peer at the WAN side; and to transcode an H.263 video stream from the communication peer at the WAN side into an H.261 video stream and send the stream to the TC.

### Embodiment 4

In this embodiment, through a UPnP action, the TCP actively requires the TS to generate a parameter description used for media communication at the LAN side.

In this embodiment, the TCP and the TS are implemented as follows:

In this embodiment, the TCP invokes a universal plug and play UPnP action, and receives a response sent from the TS in response to the invoked UPnP action, where the response includes the first media description.

The TS sends, to the TCP, a response in response to the UPnP action invoked by the TCP, where the response includes the first media description.

A specific process of this embodiment as shown in FIG. 9 may include:

Step 901: The TS completes communication negotiation and establishment with a WAN side.

Step 902: The TS sends a notification message (for example, only carrying a CallID, or/and a call status such as “CallStatus=Established”) to the TCP through a UPnP event, to notify the TCP that communication connection at the WAN side is already established.

Step 903: After obtaining the event, the TCP obtains, from the TS, a parameter description used by the TS for the media session at the LAN side.

1) During implementation, the TCP may determine, according to requirements of a user, whether the TS should establish a media session with a certain TC. That is to say, here, the TS does not actively generate a parameter used for media communication at the LAN side, unless the TS is commanded by the TCP to generate the parameter.

2) Specifically, the TCP may obtain, through a UPnP action (for example, GetMediaDescription( )), the description of a media parameter to be used by the TS at the LAN side. After receiving the request message, the TS generates a corresponding media description at the LAN side according to the media description at the WAN side, and returns the media description to the TCP through a response message.

Step 904: The TCP sends the media description SDP#1 (SDP Offer) from the TS to the TC, and the TC returns a media description SDP#2 (SDP Answer) of the TC according to SDP#1 in combination with the capability of the TC.

Step 905: The TCP sends the media description SDP#2 from the TC to the TS, and the TS compares SDP#2 with SDP#1, generates a final media parameter description SDP#1′ used for conducting a media session with the TC.

Step 906: The TCP sends the final description SDP#1′ from the TS to the TC, indicating that SDP#1′ is the final version to be used by the TS.

Step 907: The TS and the TC start a media session according to a media session parameter described in SDP#2/SDP#1′.

In this embodiment, the TCP serves as an SDP forwarder, and does not specify or partially specifies media parameters that should be used by the two parties; in this way, after the TC receives SDP#1, the capability of the TC may be different from SDP#1 (for example, a certain coding format is not supported); the TC may return SDP#2 according to the capability of the TC, and with respect to SDP#1, Case 1 is that the TC abandons a certain media stream that is not supported, and Case 2 is that the TC provides an alternative media coding format and requires the TS to perform transcoding; and the TS may determine a final version of SDP#1 according to SDP#2. The above specific example is already included in the foregoing embodiments. This embodiment is only for comparison with Embodiment 1, and reference may also be made to other embodiments for details.

### Embodiment 5

The difference between this embodiment and the foregoing embodiments lies in that, more work and decision-making rights are required for the TCP. The TCP preliminarily determines a media parameter description (SDP#2) of the TC according to the media communication parameter (SDP#0) of the TS at the WAN side in combination with the capability of the TC, and sends the description to the TS, to require the TS to generate, according to SDP#2, a final media parameter description SDP#1 that should be used; the TCP sends, to the TC, the media description SDP#1 from the TS and the media description SDP#2 that is preliminarily specified by the TCP for it, so as to instruct to generate a final media parameter description SDP#2′ according to the information; the TCP finally sends SDP#2′ to the TS, notifying the TS that SDP#2′ is a final version of the media parameter description to be used by the TC.

The advantage of the TCP preliminarily specifying a media format to be used by the TC/TS lies in that the negotiation process is exempt, which lowers the requirements on the processing capability of the TC/TS; in practice, the TCP may specify a part of parameters for the TS/TC, for example, what are specified include:

m=audio 0 RTP/AVP 0

a=rtpmap:0 PCMU/8000

m=video 0 RTP/AVP 31

a=rtpmap:31 H261/90000

That is, a media coding format that should be used for communication between the TS and the TC is specified. In this case, the TC/TS accept to use the specified media format and generate a comprehensive SDP (add information such as address and port). Or, it is specified that:

v=0

o=−0 0 IN IP4 192.168.0.10

s=

c=IN IP4 192.168.0.10/127

t=0 0

m=audio 3456 RTP/AVP 0

a=rtpmap:0 PCMU/8000

m=video 4567 RTP/AVP 31

a=rtpmap:31 H261/90000

In this way, all or main parameters for communication between the TS and the TC are specified, and the TS and the TC do not need to manage communication ports by themselves, which further lowers the requirements on the TC and the TS. In practice, the TCP may also specify a part of description content for the TS, and specify all the content including an address/port for the TC, or vice versa (depending on specific capabilities of the devices).

In this embodiment, the TCP, the TS and the TC are implemented as follows:

Before receiving the first media description sent from the TS, the TCP further includes: obtaining a media description of the TS at a wide area network WAN side and the media capability of the TC, preliminarily determining a second media description according to the media description of the TS at the WAN side and the media capability of the TC, and sending the preliminarily determined second media description to the TS; subsequently receiving the first media description which is generated by the TS according to the preliminarily determined second media description; sending the preliminarily determined second media description to the TC; receiving the second media description that is modified by the TC according to the first media description and the preliminarily determined second media description; and sending the modified second media description to the TS.

Before sending the first media description to the TCP, the TS further includes: providing a media description of the TS at a wide area network WAN side to the TCP; receiving the second media description that is preliminarily determined by the TCP according to the media description of the TS at the WAN side and the media capability of the TC; subsequently sending, to the TCP, the first media description which is generated according to the preliminarily determined second media description; and receiving the second media description which is modified by the TC according to the first media description and the preliminarily determined second media description and is forwarded by the TCP.

Before receiving the first media description, the TC provides the media capability of the TC to the TCP; receives a preliminarily determined second media description sent from the TCP and the first media description which is generated by the TS according to the preliminarily determined second media description and forwarded by the TCP, where the preliminarily determined second media description is a second media description preliminarily determined by the TCP according to the media description of the TS at a WAN side and the media capability of the TC; modifies the second media description according to the first media description and the preliminarily determined second media description; and sends the modified second media description to the TCP.

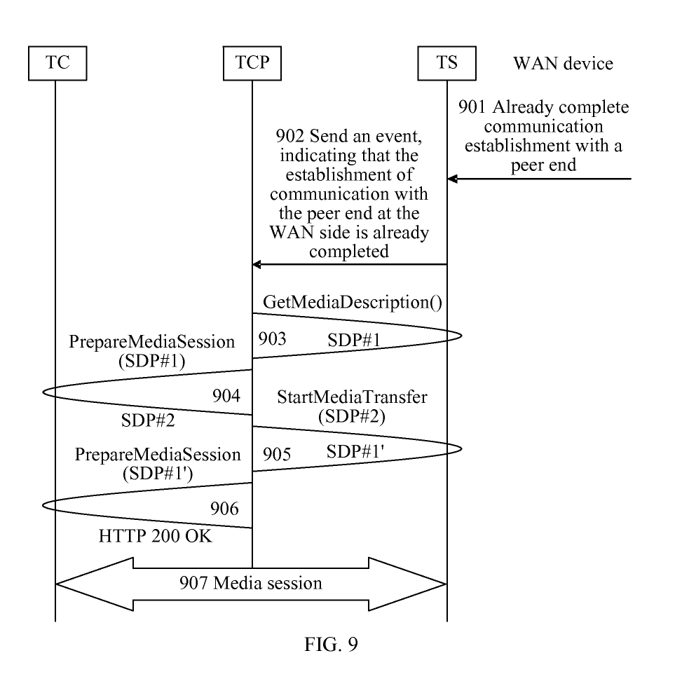

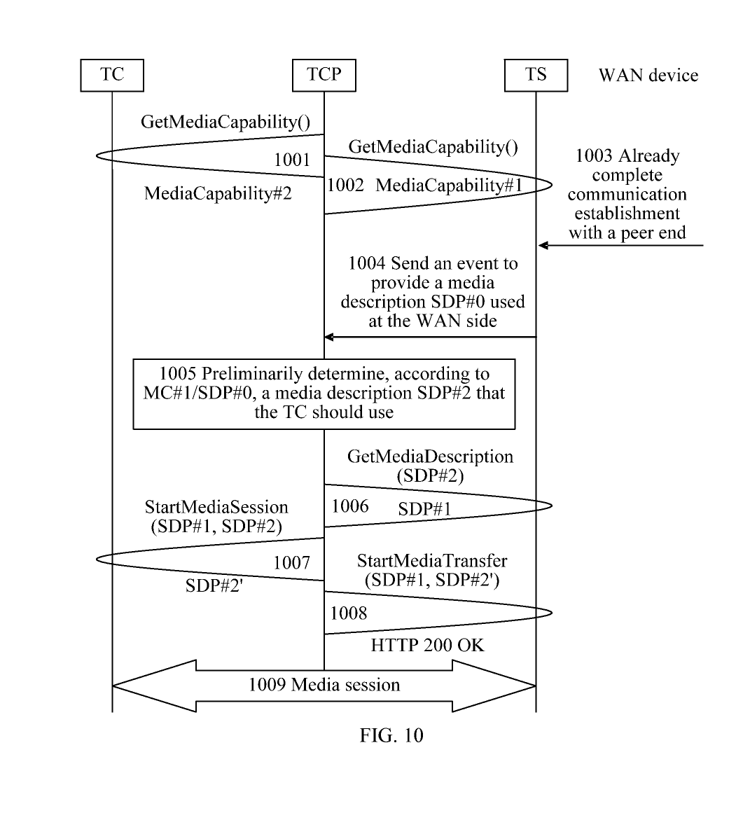

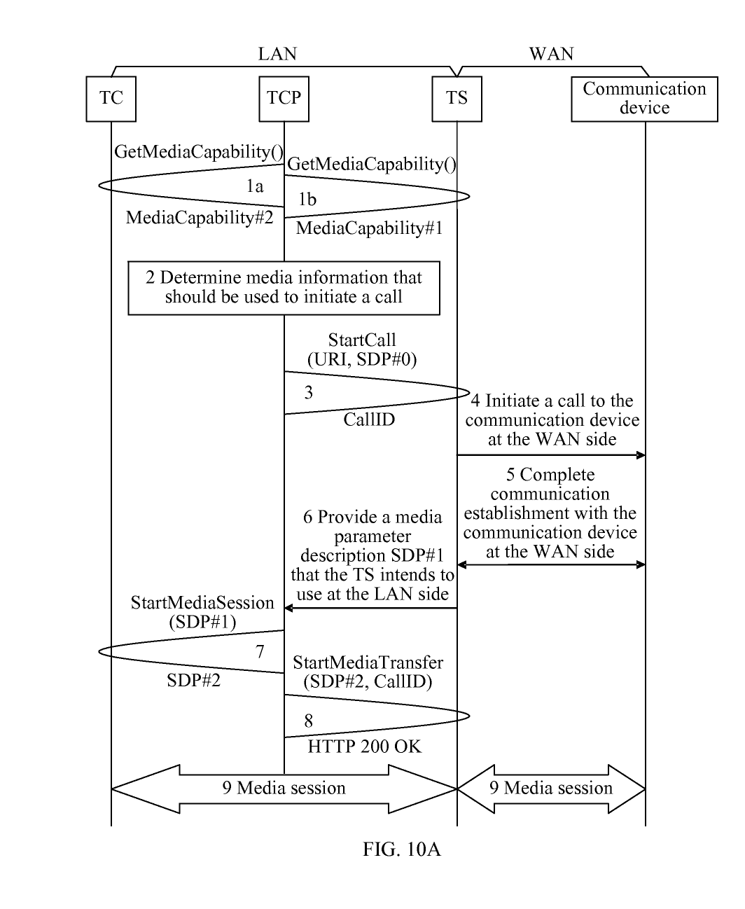

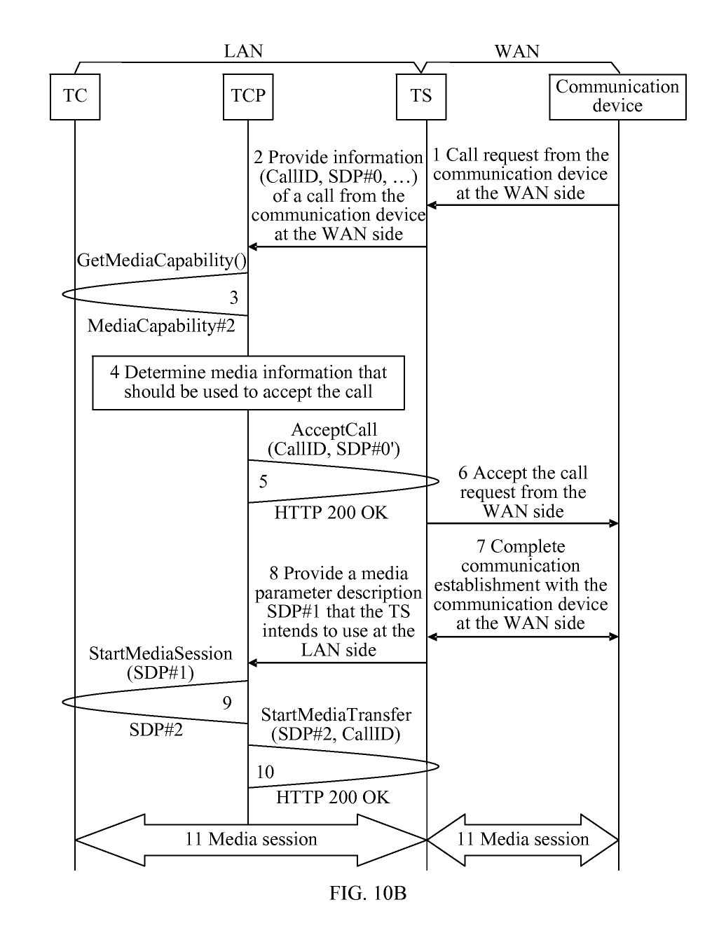

A specific process of this embodiment as shown in FIG. 10 may include:

Steps 1001a-1001b: The TCP needs to obtain media capabilities of the TS and the TC in advance.

Step 1002: The TS (such as a mobile phone, a fixed-line phone, a VoIP gateway or other devices) already completes call establishment with a communication peer at the WAN side (for example, completes an exchange process from SIP Invite to SIP ACK).

Step 1003: The TS sends a notification message (for example, only carrying a CallID, or/and a call status such as “CallStatus=Established”) to the TCP through a UPnP event, to notify the TCP that communication connection at the WAN side is already established; and provides a media description SDP#0 used at the WAN side.

Step 1004: The TCP preliminarily determines a media parameter description (SDP#2) of the TC according to the media communication parameter (SDP#0) of the TS at the WAN side and the capability of the TC.

Step 1005: The TCP provides the preliminarily determined SDP#2 to the TS; and the TS generates, according to SDP#2, a final media parameter description SDP#1 that should be used.

Step 1006: The TCP sends, to the TC, the media description SDP#1 from the TS and the media description SDP#2 that is preliminarily specified by the TCP for it; and the TC generates a final media parameter description SDP#2′ according to the information.

Step 1007: The TCP finally sends SDP#2′ to the TS, notifying the TS that SDP#2′ is a final version of the media parameter description that is to be used by the TC.

Step 1008: The TS and the TC start a media session according to media session parameters described in SDP#2/SDP#1.

Specific implementation scenarios of the embodiments of the present invention are given below through examples. The following implementation scenarios are specific instances, and during implementation, the method according to the foregoing embodiments is also applicable to other scenarios using the telephony service in the home network.

Implementation Scenario 1: The TCP initiates a session from the TS to a communication device at the WAN side, and establishes a media session between the TC and the TS. As shown in FIG. 10A, the processing process may include:

Steps 1a-1b: The TCP obtains media session capabilities (supported media types, coding and the like) of the TS and the TC. Before this, a user decides to communicate with a certain user outside the home network through the TC, and therefore triggers a call and session establishment process through the TCP.

Step 2: The TCP preliminarily determines, according to the capabilities of the TS and the TC, media parameter information (SDP#0) that should be used by the TS to initiate a call to the communication device at the WAN side.

1) Specifically, the TCP may select a media coding format that both the TS and the TC support.

2) According to the illustration of the foregoing embodiments, if the TS and the TC have no media format matched, the TCP may choose to abandon communication of this media, or select a coding format supported by the TC and require the TS to subsequently perform transcoding.

Step 3: The TCP initiates a command to the TS, instructing the TS to initiate a call to a WAN side device by using media parameters described in SDP#0. Specifically, the TCP completes this process by invoking a UPnP action, and the TS accepts the command and returns a CallID identifying a call that is to be started.

Step 4: The TS initiates a call to the WAN side device according to the instruction of the TCP and the media parameters provided by SDP#0. For example, if the SIP protocol is used, the TS sends an SIP Invite message, which may carry an SDP Offer, to a peer communication device at the WAN side.

1) The TS may organize specific content (for example, additionally determines an IP address/port or the like for receiving media streams) of the SDP Offer according to requirements in SDP#0 from the TCP.

2) The TS performs session negotiation with a WAN side device, during which multiple SIP messages are exchanged.

Step 5: The TS completes communication establishment with the WAN side device.

Step 6: The TS provides, to the TCP, a session parameter description SDP#1 used for media communication at the WAN side.

1) For example, through exchange of multiple SIP messages, the TS and the communication peer determine media session parameters used by the TS and the communication peer.

2) The TS generates a parameter description SDP#1, which is used for communication at the LAN side, according to the media parameters used at the WAN side. According to the foregoing embodiments, the TCP may also send an instruction to the TS, to require the TS to generate a parameter description for communication at the LAN side (the instruction may also carry the media capability/parameter information of the TC).

3) The TS provides, to the TCP, the parameter description SDP#1 used for the media session at the LAN side. According to the foregoing embodiments, the providing manner may be that the TS sends an event to the TCP, or that the TCP invokes an action and obtains it from the TS.

Step 7: The TCP sends information of the media description SDP#1 from the TS to the TC. According to the foregoing embodiments, specific implementation may be:

1) The TCP sends SDP#1 to the TC, so that the TC returns, according to capacities of the TC, the description SDP#2 of a media parameter used by the TC.

2) The TCP modifies SDP#1 according to the capacities of the TC, and sends SDP#1′ to the TC, and the TC accepts SDP#1′ and returns the description SDP#2 of a media parameter to be used.

3) According to SDP#1 and the capability of the TC, the TCP directly determines and sends the description SDP#2 of a media parameter, which should be used, to the TC, and the TC accepts the SDP#2.

Step 8: The TCP sends, to the TS, the description SDP#2 of the media parameter to be used by the TC in the media session, so that a media session between the TS and the TC is started.

1) If the TC sends SDP#1′ to the TS, in this case, the TCP should also provide SDP#1′ to the TS, so as to notify TS of the final version of media parameter that should be used.

Step 9: The TC and the TS start a media session according to media parameters described in SDP#1 (SDP#1′)/SDP#2, and the TS may also send all or a part of media between the TS and the TC to the communication peer at the WAN side, and send all or a part of media from the communication peer at the WAN side to the TC, during which the TS may perform a transcoding operation on media in all or a part of coding formats.

Implementation Scenario 2: The TCP accepts a session request from the communication device at the WAN side to the TS, and establishes a media session between the TC and the TS. As shown in FIG. 10B, the processing process may include:

Step 1: The TS receives a call request from the communication device at the WAN side.

Step 2: The TS provides the call request to the TCP.

1) The information provided by the TS to the TCP may include: a CallID which is generated by the TS according to the request and is used for identifying a current call; and the description SDP#0 of media session parameters. Herein, SDP#0 may be media capability information carried in an SDP Offer provided by the communication peer, or media capability information provided to the TCP by the TS after filtering it according to the capability of the TS.

2) The manner in which the TS provides the information to the TCP may be: through an event, or that the TCP invokes an action and the TS returns the information through a response message.

Step 3: The TCP obtains media capability information MediaCapability#1 of the TC.

Optionally, the TCP may also obtain the capability of the TS.

Step 4: The TCP determines, according to SDP#0, media session parameters SDP#0′ that are intended to be used by the TS after the TS accepts the request.

For the manner in which the TCP determines SDP#0′, for example, SDP#0 includes multiple media coding formats, such as H.261 and H.263, supported by the communication peer at the WAN side, and the TCP determines, according to the capabilities of the TC (and the TS), that H.261 is used to transmit video during a current session, and accordingly SDP#0′ includes selection of the H.261 coding format.

Step 5: The TCP commands the TS to accept the call request from the WAN side. The accepting manner may be invoking a UPnP action, where the description SDP#0′ of media parameter information that the TS should select is carried.

Step 6: According to the command of the TCP, the TS organizes and returns an SDP Answer to a WAN side device. For example, an SIP protocol is used, and the TS may carry the SDP Answer in an SIP message.

Step 7: The TS completes session negotiation and call establishment with the communication device at the WAN side according to the instruction of the TCP. At this time, the TS provides, to the TC, the description SDP#1 of media session parameters for use at the LAN side according to the manners described in the foregoing embodiments.

Subsequent steps 8-11 are the same as steps 6-9 in FIG. 10A.

Persons of ordinary skill in the art should understand that all or a part of the steps in the method according to the embodiments can be implemented by a program instructing relevant hardware, and the program may be stored in a computer readable storage medium. When the program is executed, all or a part of the steps in the method according to the embodiments are performed. The storage medium may include a ROM, a RAM, a magnetic disk or an optical disk.

Embodiments of the present invention further provide a telephony control point device TCP, a telephony server device TS, a telephony client device TC and a media negotiation system, as described in the following embodiments. As the principle of the devices for solving the problems is similar to that of the media negotiation method, reference may be made to the implementation of the method for the implementation of the devices, and the same part will not be repeatedly described herein.

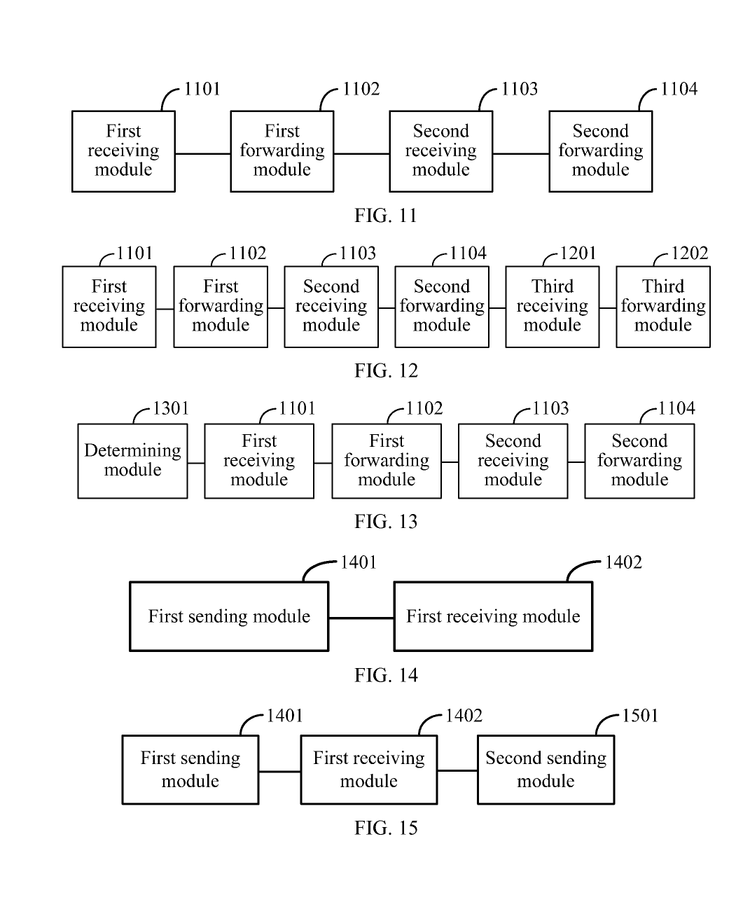

As shown in FIG. 11, the telephony control point device TCP in the embodiments of the present invention may include:

a first receiving module 1101, configured to receive a first media description sent from a telephony server TS, where the first media description includes a media session parameter of the TS at a LAN side;

a first forwarding module 1102, configured to forward the first media description to a telephony client TC;

a second receiving module 1103, configured to receive a second media description which is generated by the TC according to the first media description, where the second media description includes a media session parameter of the TC; and
a second forwarding module 1104, configured to forward the second media description to the TS.

In an embodiment, the first forwarding module 1102 may be specifically configured to:

obtain the media capability of the TC and modify the first media description according to the media capability of the TC; or, obtain media capabilities of the TC and the TS and modify the first media description according to the media capabilities of the TC and the TS; and

forward the modified first media description to the TC; and

the second receiving module 1103 may be specifically configured to: receive the second media description which is generated by the TC according to the modified first media description.

In an embodiment, the second forwarding module 1104 may be further configured to: forward the modified first media description to the TS.

As shown in FIG. 12, in an embodiment, the TCP shown in FIG. 11 may further include:

a third receiving module 1201, configured to receive the first media description modified by the TS according to the first media description and the second media description; and

a third forwarding module 1202, configured to forward the modified first media description to the TC.

In an embodiment, the first forwarding module 1102 may be further configured to: obtain the media capability of the TS and forward the media capabilities of the TS to the TC; and

the second receiving module 1103 may be specifically configured to: receive the second media description which is generated by the TC according to the media capabilities of the TS and TC and the first media description.

As shown in FIG. 13, in an embodiment, the TCP shown in FIG. 11 may further include:

a determining module 1301, configured to obtain a media description of the TS at a wide area network WAN side and the media capability of the TC, preliminarily determine a second media description according to the media description of the TS at the WAN side and the media capability of the TC, and send the preliminarily determined second media description to the TS; where

the first receiving module 1101 may be specifically configured to: receive the first media description which is generated by the TS according to the preliminarily determined second media description;

the first forwarding module 1102 may be further configured to: send the preliminarily determined second media description to the TC;

the second receiving module 1103 may be specifically configured to: receive the second media description which is modified by the TC according to the first media description and the preliminarily determined second media description; and

the second forwarding module 1104 may be specifically configured to: send the modified second media description to the TS.

In an embodiment, the first receiving module 1101 may be specifically configured to:

receive the first media description, which is sent from the TS, through an event;

or, invoke a universal plug and play UPnP action, and receive a response that is sent from the TS and is in response to the invoked UPnP action, where the response includes the first media description.

As shown in FIG. 14, the telephony server device TS in the embodiments of the present invention may include:

a first sending module 1401, configured to send a first media description to a telephony control point TCP, where the first media description includes a media session parameter of the TS at a LAN side; and

a first receiving module 1402, configured to receive a second media description which is generated by a TC according to the first media description and forwarded by the TCP, where the second media description includes a media session parameter of the TC.

In an embodiment, the first receiving module 1402 may be specifically configured to: receive the modified first media description and the second media description which is generated by the TC according to the modified first media description, where the modified first media description is obtained after the TCP modifies the first media description according to the media capability of the TC, or obtained after the TCP modifies the first media description according to media capabilities of the TC and the TS.

As shown in FIG. 15, in an embodiment, the TS shown in FIG. 14 may further include:

a second sending module 1501, configured to send the first media description that is modified according to the first media description and the second media description to the TCP.

In an embodiment, the first receiving module 1402 may be specifically configured to: receive the second media description which is generated by the TC according to media capabilities of the TS and the TC and the first media description and is forwarded by the TCP.

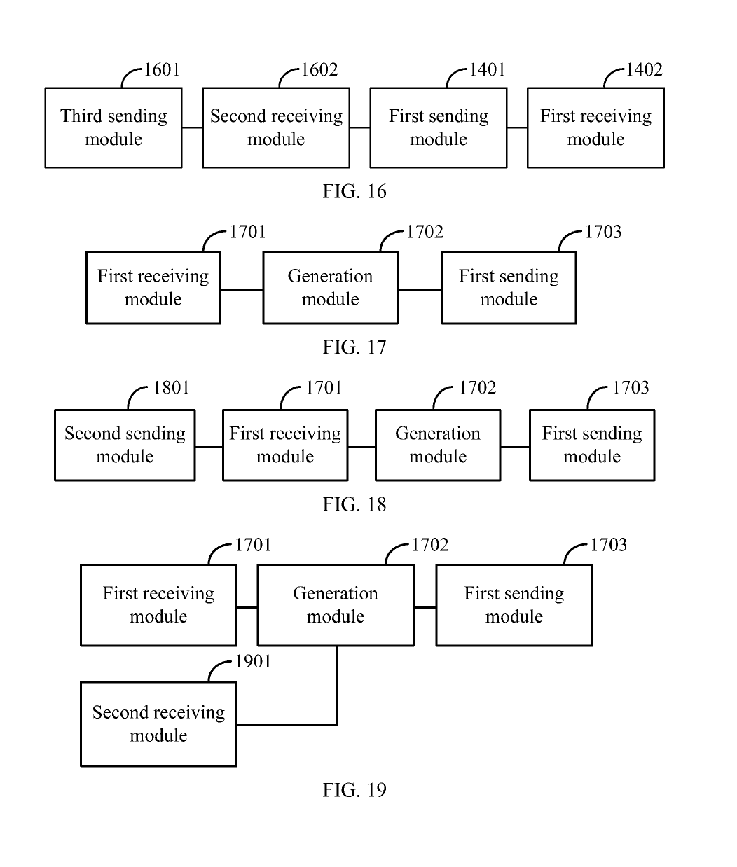

As shown in FIG. 16, in an embodiment, the TS shown in FIG. 14 may further include:

a third sending module 1601, configured to provide a media description of the TS at a wide area network WAN side to the TCP; and

a second receiving module 1602, configured to receive the second media description that is preliminarily determined by the TCP according to the media description of the TS at the WAN side and the media capability of the TC; where

the first sending module 1401 may be specifically configured to: send the first media description which is generated according to the preliminarily determined second media description to the TCP; and

the first receiving module 1402 may be specifically configured to: receive the second media description which is modified by the TC according to the first media description and the preliminarily determined second media description and is forwarded by the TCP.

In an embodiment, the first sending module 1401 may be specifically configured to:

send the first media description to the TCP through an event;

or, send a response to the TCP in response to a UPnP action invoked by the TCP, where the response includes the first media description.

As shown in FIG. 17, the telephony client device TC in the embodiments of the present invention may include:

a first receiving module 1701, configured to receive a first media description of a TS which is forwarded by a TCP, where the first media description includes a media session parameter of the TS at a LAN side;

a generation module 1702, configured to generate a second media description according to the first media description, where the second media description includes a media session parameter of the TC; and

a first sending module 1703, configured to send the second media description to the TCP, so that the TCP sends the second media description to the TS.

As shown in FIG. 18, in an embodiment, the TC shown in FIG. 17 may further include:

a second sending module 1801, configured to provide the media capability of the TC to the TCP; where

the first receiving module 1701 may be specifically configured to: receive the first media description that is modified by the TCP according to the media capability of the TC or according to the media capabilities of the TC and the TS after the TCP receives the first media description sent from the TS; and

the generation module 1702 may be specifically configured to: generate a second media description according to the modified first media description.

As shown in FIG. 19, in an embodiment, the TC shown in FIG. 17 may further include:

a second receiving module 1901, configured to receive the media capability of the TS which is forwarded by the TCP; where

the generation module 1702 may be specifically configured to: generate the second media description according to the media capabilities of the TS and the TC and the first media description.

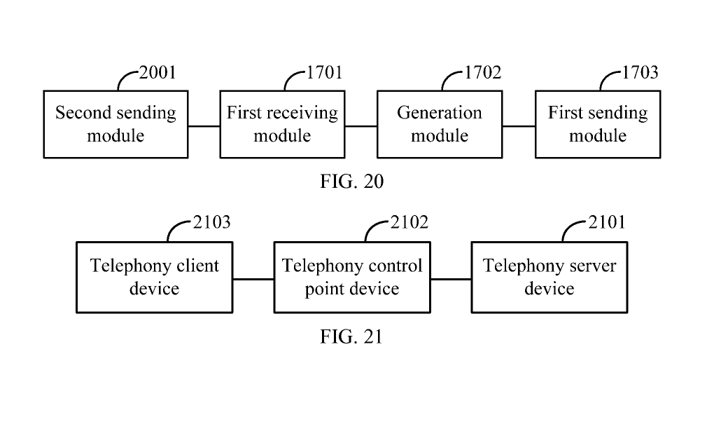

As shown in FIG. 20, in an embodiment, the TC shown in FIG. 17 may further include:

a second sending module 2001, configured to provide the media capability of the TC to the TCP; where

the first receiving module 1701 may be specifically configured to: receive a preliminarily determined second media description sent from the TCP and the first media description which is generated by the TS according to the preliminarily determined second media description and forwarded by the TCP, where the preliminarily determined second media description is a second media description preliminarily determined by the TCP according to a media description of the TS at a WAN side and the media capability of the TC;

the generation module 1702 may be specifically configured to: modify the second media description according to the first media description and the preliminarily determined second media description; and

the first sending module 1703 may be specifically configured to: send the modified second media description to the TCP.

In an embodiment, the generation module 1702 may be specifically configured to: generate the second media description according to any one of or any combination of media format information, address information and port information in the first media description.

As shown in FIG. 21, a media negotiation system in the embodiments of the present invention may include:

a telephony server device TS 2101, configured to send a first media description, where the first media description includes a media session parameter of the TS at a local area network LAN side;

a telephony control point device TCP 2102, configured to receive the first media description, and forward the first media description;

and a telephony client device TC 2103, configured to receive the first media description which is forwarded by the TCP, generate a second media description according to the first media description, and send the second media description to the TCP;

where the TCP is further configured to receive the second media description which is sent from the TC, and send the second media description to the TS.

Based on the above description, in the embodiments of the present invention, a first media description sent from a telephony server TS is received, where the first media description includes a media session parameter of the TS at a LAN side; the first media description is forwarded to a telephony client TC; a second media description which is generated by the TC according to the first media description is received, where the second media description includes a media session parameter of the TC; and the second media description is forwarded to the TS, thereby achieving negotiation of media session parameters between a telephony server and a telephony client in a home network.

In the embodiments of the present invention, a first media description is sent to a telephony control point TCP, where the first media description includes a media session parameter of a TS at a LAN side; and a second media description which is generated by a TC according to the first media description and forwarded by the TCP is received, where the second media description includes a media session parameter of the TC, thereby achieving negotiation of media session parameters between a telephony server and a telephony client in a home network.

In the embodiments of the present invention, a first media description of a TS which is forwarded by a TCP is received, where the first media description includes a media session parameter of the TS at a LAN side; a second media description is generated according to the first media description, where the second media description includes a media session parameter of a TC; and the second media description is sent to the TCP, so that the TCP sends the second media description to the TS, thereby achieving negotiation of media session parameters between a telephony server and a telephony client in a home network.

The objectives, technical solutions, and beneficial effects of the present invention have been described in further detail through the specific embodiments. It should be understood that the above description is merely specific embodiments of the present invention, but not intended to limit the protection scope of the present invention. Any modifications, equivalent replacements, or improvements made without departing from the spirit and principle of the present invention should fall within the protection scope of the present invention.

What is claimed is:

1. A method for media session negotiation, comprising:
receiving a first media description sent from a telephony server TS, wherein the first media description comprises a media session parameter of the TS at a local area network LAN side;
forwarding the first media description to a telephony client TC;
receiving a second media description which is generated by the TC according to the first media description, wherein the second media description comprises a media session parameter of the TC; and
forwarding the second media description to the TS.

2. The method according to claim 1, wherein the first media description further comprises media session information of the TS at a wide area network WAN side.

3. The method according to claim 2, wherein the media session information of the TS at the WAN side comprises a media code used by the TS at the WAN side; and
the media session parameter of the TS at the LAN side comprises any one or any combination of a receiving media address, a receiving media port and a used media code of the TS at the LAN side.

4. The method according to claim 1, wherein the forwarding the first media description to the TC comprises:
obtaining a media capability of the TC and modifying the first media description according to the media capability of the TC; or, obtaining media capabilities of the TC and the TS and modifying the first media description according to the media capabilities of the TC and the TS; and
forwarding the modified first media description to the TC; and
the receiving the second media description which is generated by the TC according to the first media description comprises: receiving the second media description which is generated by the TC according to the modified first media description.

5. The method according to claim 4, further comprising:
forwarding the modified first media description to the TS.

6. The method according to claim 1, further comprising:
receiving a modified first media description from the TS, wherein the modified first media description is obtained after the TS modifies the first media description according to the first media description and the second media description; and
forwarding the modified first media description to the TC.

7. The method according to claim 1, wherein before the receiving the second media description which is generated by the TC according to the first media description, the method further comprises:
obtaining a media capability of the TS and forwarding the media capabilities of the TS to the TC; and
the receiving the second media description which is generated by the TC according to the first media description comprises: receiving the second media description which is generated by the TC according to the media capabilities of the TS and TC and the first media description.

8. The method according to claim 1, wherein before the receiving the first media description sent from the TS, the method further comprising:
obtaining a media description of the TS at a WAN side and a media capability of the TC, preliminarily determining the second media description according to the media description of the TS at the WAN side and the media capability of the TC, and sending the preliminarily determined second media description to the TS;
the receiving the first media description sent from the TS comprises: receiving the first media description which is generated by the TS according to the preliminarily determined second media description;
before the receiving the second media description which is generated by the TC according to the first media description, the method further comprises: sending the preliminarily determined second media description to TC;
the receiving the second media description which is generated by the TC according to the first media description comprises: receiving a modified second media description from the TC, wherein the modified second media description is obtained after the TC modifies the second media description according to the first media description and the preliminarily determined second media description; and
the forwarding the second media description to the TS comprises: sending the modified second media description to the TS.

9. The method according to claim 1, wherein the receiving the first media description sent from the TS comprises:
receiving the first media description, which is sent from the TS, through an event;
or, invoking a universal plug and play UPnP action, and receiving a response that is sent from the TS and is in response to the invoked UPnP action, wherein the response comprises the first media description.

10. A method for media session negotiation, comprising:
sending a first media description to a telephony control point TCP, wherein the first media description comprises a media session parameter of a TS at a LAN side; and
receiving a second media description which is generated by a TC according to the first media description and forwarded by the TCP, wherein the second media description comprises a media session parameter of the TC.

11. The method according to claim 10, wherein the receiving the second media description which is generated by the TC according to the first media description and forwarded by the TCP comprises: receiving a modified first media description and the second media description which is generated by the TC according to the modified first media description, wherein the modified first media description is obtained after the TCP modifies the first media description according to a media capability of the TC, or obtained after the TCP modifies the first media description according to media capabilities of the TC and the TS.

12. The method according to claim 10, further comprising:
modifying the first media description according to the first media description and the second media description to obtain the modified first media description; and
sending the modified first media description to the TCP, so that the TCP sends the modified first media description to the TC.

13. The method according to claim 10, wherein the receiving the second media description which is generated by the TC according to the first media description and forwarded by the TCP comprises: receiving the second media description which is generated by the TC according to media capabilities of the TS and the TC and the first media description and forwarded by the TCP.

14. The method according to claim 10, wherein before the sending the first media description to the TCP, the method further comprises: providing a media description of the TS at a WAN side to the TCP; and receiving the second media description which is preliminarily determined by the TCP according to the media description of the TS at the WAN side and a media capability of the TC;
the sending the first media description to the TCP comprises: sending the first media description which is generated according to the preliminarily determined second media description to the TCP; and
the receiving the second media description which is generated by the TC according to the first media description and forwarded by the TCP is specifically: receiving a modified second media description which is from the TC and forwarded by the TCP, wherein the modified second media description is obtained after the TC modifies the second media description according to the first media description and the preliminarily determined second media description.

15. A method for media session negotiation, comprising:
receiving a first media description of a TS which is forwarded by a TCP, wherein the first media description comprises a media session parameter of the TS at a LAN side;
generating a second media description according to the first media description, wherein the second media description comprises a media session parameter of a TC; and
sending the second media description to the TCP, so that the TCP sends the second media description to the TS.

16. The method according to claim 15, wherein before the receiving the first media description, the method comprises: providing a media capability of the TC to the TCP;
the receiving the first media description of the TS which is forwarded by the TCP comprises:
receiving the first media description that is modified by the TCP according to the media capability of the TC or according to media capabilities of the TC and the TS after the TCP receives the first media description sent from the TS; and
the generating the second media description according to the first media description comprises:
generating the second media description according to the modified first media description.

17. The method according to claim 15, further comprising:
receiving a modified first media description which is from the TS and forwarded by the TCP, wherein the modified first media description is obtained after the TS modifies the first media description according to the first media description and the second media description.

18. The method according to claim 15, wherein before the generating the second media description according to the first media description, the method comprises: receiving a media capability of the TS which is forwarded by the TCP; and
the generating the second media description according to the first media description comprises: generating the second media description according to media capabilities of the TS and the TC and the first media description.

19. The method according to claim 15, wherein before the receiving the first media description of the TS which is forwarded by the TCP, the method comprises: providing a media capability of the TC to the TCP;
the receiving the first media description of the TS which is forwarded by the TCP comprises: receiving a preliminarily determined second media description sent from the TCP and the first media description which is generated by the TS according to the preliminarily determined second media description and forwarded by the TCP, wherein the preliminarily determined second media description is a second media description preliminarily determined by the TCP according to a media description of the TS at a WAN side and the media capability of the TC;
the generating the second media description according to the first media description comprises: modifying the second media description according to the first media description and the preliminarily determined second media description; and
the sending the second media description to the TCP comprises: sending the modified second media description to the TCP.

20. A telephony control point device TCP, comprising:
a first receiving module, configured to receive a first media description sent from a telephony server TS, wherein the first media description comprises a media session parameter of the TS at a LAN side;
a first forwarding module, configured to forward the first media description to a telephony client TC;
a second receiving module, configured to receive a second media description which is generated by the TC according to the first media description, wherein the second media description comprises a media session parameter of the TC; and
a second forwarding module, configured to forward the second media description to the TS.

21. The TCP according to claim 20, wherein the first forwarding module is specifically configured to:
obtain a media capability of the TC and modify the first media description according to the media capability of the TC; or, obtain media capabilities of the TC and the TS and modify the first media description according to the media capabilities of the TC and the TS; and
forward the modified first media description to the TC; and
the second receiving module is specifically configured to: receive the second media description which is generated by the TC according to the modified first media description.

22. The TCP according to claim 21, wherein
the second forwarding module is further configured to: forward the modified first media description to the TS.

23. The TCP according to claim 22, further comprising:
a third receiving module, configured to receive the modified first media description from the TS, wherein the modified first media description is obtained after the TS modifies the first media description according to the first media description and the second media description; and
a third forwarding module, configured to forward the modified first media description to the TC.

24. The TCP according to claim 20, wherein the first forwarding module is further configured to: obtain a media capability of the TS and forward the media capabilities of the TS to the TC; and
the second receiving module is specifically configured to: receive the second media description which is generated by the TC according to media capabilities of the TS and TC and the first media description.

25. The TCP according to claim 20, further comprising:
a determining module, configured to obtain a media description of the TS at a WAN side and a media capability of the TC, preliminarily determine a second media description according to the media description of the TS at the WAN side and the media capability of the TC, and send the preliminarily determined second media description to the TS; wherein
the first receiving module is specifically configured to: receive the first media description which is generated by the TS according to the preliminarily determined second media description;
the first forwarding module is further configured to: send the preliminarily determined second media description to the TC;
the second receiving module is specifically configured to: receive a modified second media description from the TC, wherein the modified second media description is obtained after the TC modifies the second media description according to the first media description and the preliminarily determined second media description; and
the second forwarding module is specifically configured to: send the modified second media description to the TS.

26. A telephony server device TS, comprising:
a first sending module, configured to send a first media description to a telephony control point TCP, wherein the first media description comprises a media session parameter of the TS at a LAN side; and
a receiving module, configured to receive a second media description which is generated by a TC according to the first media description and forwarded by the TCP, wherein the second media description comprises a media session parameter of the TC.

27. The TS according to claim 26, wherein the receiving module is specifically configured to:
receive a modified first media description and the second media description which is generated by the TC according to the modified first media description, wherein the modified first media description is obtained after the TCP modifies the first media description according to a media capability of the TC, or obtained after the TCP modifies the first media description according to media capabilities of the TC and the TS.

28. The TS according to claim 26, further comprising:
a second sending module, configured to send the first media description that is modified according to the first media description and the second media description to the TCP.

29. The TS according to claim 26, wherein the receiving module is specifically configured to:
receive the second media description which is generated by the TC according to media capabilities of the TS and the TC and the first media description and forwarded by the TCP.

30. The TS according to claim 26, further comprising:
a third sending module, configured to provide a media description of the TS at a WAN side to the TCP; and receive the second media description that is preliminarily determined by the TCP according to the media description of the TS at the WAN side and a media capability of the TC; wherein
the first sending module is specifically configured to: send the first media description which is generated according to the preliminarily determined second media description to the TCP; and
the receiving module is specifically configured to: receive a modified second media description which is from the TC and forwarded by the TCP, wherein the modified second media description is obtained after the TC modifies the second media description according to the first media description and the preliminarily determined second media description.

31. A telephony client device TC, comprising:
a first receiving module, configured to receive a first media description of a TS which is forwarded by a TCP, wherein the first media description comprises a media session parameter of the TS at a LAN side;
a generation module, configured to generate a second media description according to the first media description, wherein the second media description comprises a media session parameter of the TC; and
a first sending module, configured to send the second media description to the TCP, so that the TCP sends the second media description to the TS.

32. The TC according to claim 31, further comprising:
a second sending module, configured to provide a media capability of the TC to the TCP; wherein
the first receiving module is specifically configured to: receive the first media description modified by the TCP according to the media capability of the TC or according to media capabilities of the TC and the TS after the TCP receives the first media description sent from the TS; and
the generation module is specifically configured to: generate the second media description according to the modified first media description.

33. The TC according to claim 31, further comprising:
a second receiving module, configured to receive a media capability of the TS which is forwarded by the TCP; wherein
the generation module is specifically configured to: generate the second media description according to media capabilities of the TS and the TC and the first media description.

34. The TC according to claim 31, further comprising:
a second sending module, configured to provide a media capability of the TC to the TCP; wherein
the first receiving module is specifically configured to: receive a preliminarily determined second media description sent from the TCP and the first media description which is generated by the TS according to the preliminarily determined second media description and forwarded by the TCP, wherein the preliminarily determined second media description is a second media description preliminarily determined by the TCP according to a media description of the TS at a WAN side and the media capability of the TC;
the generation module is specifically configured to: modify the second media description according to the first media description and the preliminarily determined second media description; and
the first sending module is specifically configured to: send the modified second media description to the TCP.

35. A media negotiation system, comprising:
a telephony server device TS, configured to send a first media description, wherein the first media description comprises a media session parameter of the TS at a local area network LAN side;
a telephony control point device TCP, configured to receive the first media description, and forward the first media description;
and a telephony client device TC, configured to receive the first media description which is forwarded by the TCP, generate a second media description according to the first media description, and send the second media description to the TCP;
wherein the TCP is further configured to receive the second media description which is sent from the TC, and send the second media description to the TS.
